(19) United States
(12) Patent Application Publication
(10) Pub. No.: US 2010/0088526 A1
(43) Pub. Date: Apr. 8, 2010

(54) System and Method for Modular Exponentiation

(75) Inventors: Santosh Kumar, Santa Clara, CA (US); Senthilmurugan Thirunavukkarasu, Sunnyvale, CA (US)

Correspondence Address: The TPL Group, 20400 Stevens Creek Blvd., Fifth Floor, Cupertino, CA, 95014, US

(73) Assignee: MCM PORTFOLIO LLC, Cupertino, CA (US)

(21) Appl. No.: 12/359,182

(22) Filed: Jan. 23, 2009

Related U.S. Application Data
(60) Provisional application No. 61/102,107, filed on Oct. 2, 2008.

(51) Int. Cl. G06F 12/14; H04L 9/28

(52) U.S. Cl. 713/193; 380/28

(57) ABSTRACT

To calculate the equation y=x^{e} mod n, integral to solving cryptographic and authentication problems, much computing power is required despite elegant algorithms that greatly reduce the number of calculations required. Operations involved in computing this equation include shifting bits, comparing values, subtracting, and adding. This invention provides an improvement over prior calculation methods by pinpointing places where computing cycles can be eliminated.

### CROSS-REFERENCE TO RELATED APPLICATION

This application claims priority to and the benefit of provisional patent application U.S. Ser. No. 61/102,107, filed Oct. 2, 2008, hereby incorporated by reference in its entirety.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

This invention relates to increasing the efficiency of performing modular exponentiation operations which, for example, are integral to cryptographic key operations.

### BACKGROUND

With the prevalence of public computer networks used to transmit confidential data for personal, business, and governmental purposes, many computer users need cryptographic systems to control access to their data.

Cryptographic systems are commonly used to restrict unauthorized access to messages communicated over otherwise insecure channels. In general, cryptographic systems use a unique key, such as a series of numbers, to control an algorithm used to encrypt a message before it is transmitted over an insecure communication channel to a receiver. With a private key cryptographic system, both the sender and receiver must have access to the same key in order to encode and decode encrypted messages. The key can be exchanged in advance over a secure channel. However, secure communication of the key is hampered by the unavailability and expense of secure communication channels. Moreover, the need to communicate the key in advance impedes the spontaneity of business communications.

Overcoming the difficulty and inconvenience of communicating the key over a secure channel, a public key cryptographic system permits a key to be communicated over an insecure channel without jeopardizing security. This system utilizes a pair of keys in which one is publicly communicated, i.e., a public key, and the other is kept secret by a receiver, i.e., a private key. While the private key is mathematically related to the public key, it is extraordinarily difficult to derive the private key from the public key alone. Using this system, a sender uses the public key to encrypt a message, and a receiver uses the private key to decrypt the message. This procedure has the added benefit of permitting the publication and dissemination of the public key, allowing any number of senders to communicate in a secure manner with the holder of the private key.

FIG. 1 is a block diagram of a data communications system including an encryption section (transmission side) and a decryption section (receiving side). When plain text M is inputted, the encryption section enciphers M according to the encryption keys n, e and transmits the encryption result C to the decryption section. The decryption section deciphers the encryption result C according to decryption key n, d=f(e) and outputs plain text (decryption result) M.

Such cryptographic systems require computation of modular exponentiations of the form:

C=M^{e} mod n and

M=C^{d} mod n

in which exponent e and modulus n are large numbers, e.g., having a length of 1024, 2048, or 4096 binary digits or bits.

However, modular exponentiation calculations of this magnitude are a daunting task even to an authorized receiver using a high speed computer. The difficulty of modular exponentiation calculations drains computer resources and degrades data throughput rates, and thus represents a major impediment to the widespread adoption of commercial cryptographic systems.

Techniques have been developed to reduce this task to a more manageable, although still computationally intensive, undertaking For example, modular exponentiation is often implemented in hardware. One hardware technique, of interest in this patent application, is termed multiplication by shifting or binary multiplication.

FIG. 2 is a flow chart of a binary multiplication method. Binary multiplication operates by repeated shifting and adding of registers or other computer memory locations. Starting with a memory location set to zero, a second multiplicand is shifted to correspond with each 1 in the first multiplicand and added to the memory location. Shifting each position left is equivalent to multiplying by 2, just as in decimal representation a shift left is equivalent to multiplying by 10.

The algorithm may be stated as follows:

| | |
|---|---|
| Product ← 0 | (step 202) |
| While Multiplier is not 0 do | (step 206) |
| { | |
| If right-most bit of multiplier = 1 then | (step 210) |
| Product ← Product + Multiplicand | (step 214) |
| Left Shift Multiplicand | (step 218) |
| Right Shift Multiplier | (step 222) |
| } | |
| Done | (step 226) |

Yet even with the method of binary multiplication, solving a modular exponentiation problem is still computer intensive. Accordingly, a critical need exists for a high speed modular exponentiation method and apparatus to provide a sufficient level of communication security while minimizing the demand for computer system resources, including data throughput, CPU size, and electric power. This application focuses on increasing the efficiency of binary multiplication. Where speed is paramount, up to requiring the employment of all available resources, this invention is compatible with and complementary to other schemes for more rapidly executing public key cryptographic system calculations.

### SUMMARY OF THE INVENTION

To calculate the equation y=b^{e} mod n, integral to solving cryptographic problems, much computing power is required despite elegant algorithms that greatly reduce numbers of calculations involved. Operations needed to compute this equation include shifting bits, comparing values, subtracting, and adding. This invention provides an improvement over prior calculation methods by pinpointing places where the number of required computing cycles can be reduced.

One embodiment of this invention involves reversing the order of accessing “rows” and “columns” of memory registers or locations. Instead of fetching one row at a time of a named set of registers (e.g., a row of temporary registers) in sequence, a row of dissimilar registers (e.g., a row containing one temporary register, a multiplier register, and a multiplicand register) is fetched.

The details of the present invention, both as to its structure and operation, and many of the attendant advantages of this invention, can best be understood in reference to the following detailed description, when taken in conjunction with the accompanying drawings, in which like reference numerals refer to like parts throughout the various views unless otherwise specified, and in which:

### BRIEF DESCRIPTION OF DRAWINGS

FIG. 1 is a block diagram of a data communications system including an encryption section (transmission side) and a decryption section (receiving side).

FIG. 2 is a flow chart of a binary multiplication method.

FIG. 3 is a top level block diagram of a device to compute public key message decryption and encryption.

FIG. 4 (prior art) illustrates a memory utilized in conjunction with public key message decryption and encryption.

FIG. 5 illustrates a memory utilized in conjunction with public key message decryption and encryption in accordance with the present invention.

FIG. 6 shows a modulus multiplier in accordance with the present invention.

FIG. 7 is an overview flowchart of the inventive method described herein.

FIGS. 8a, 8b, 8c, 8d, 8e, 8f, and 8g are detailed flowcharts showing the inventive method described herein.

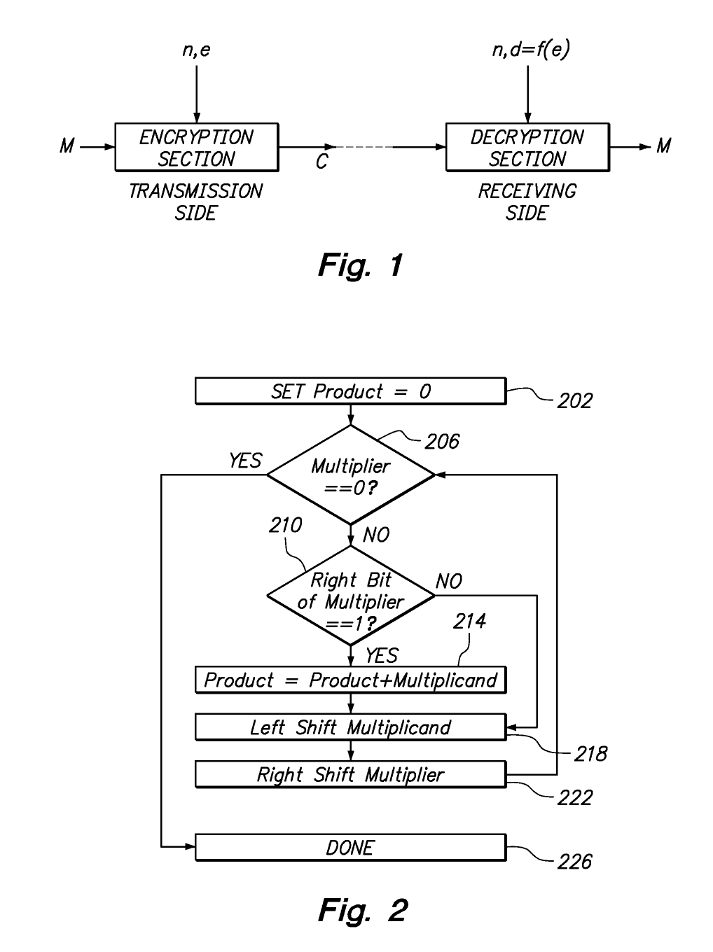

### DETAILED DESCRIPTION

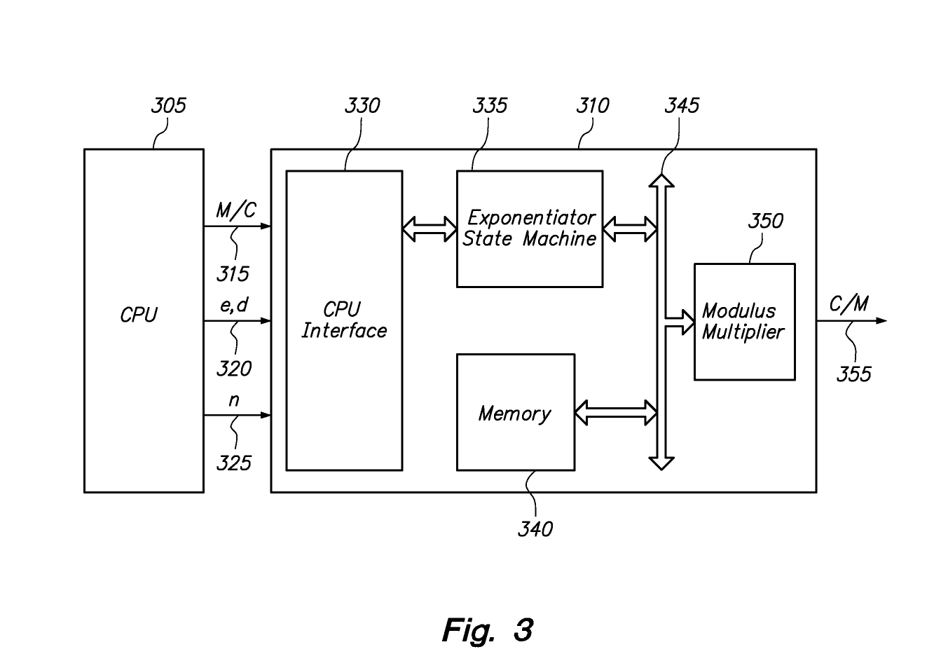

FIG. 3 is a block diagram of an implementation of the invention in a hardware system level design, which entails coupling CPU 305 to controller 310. CPU 305 provides data input 315 of M or C, data input 320 of exponent e or d, and data input 325 of modulus n to the controller 310 to perform encryption or decryption respectively and generate data output 355 of C or M. The controller 310 contains CPU interface 330 which is coupled to CPU 305 and an exponentiator state machine 335. CPU interface acts as a communication medium between the CPU 305 and exponentiator state machine 335 which in turn is coupled to memory 340 and modulus multiplier 350 using the communication bus 345.

In the following examples, “n” refers to the product of two, or more, distinct prime numbers. The value “e” is a public key exponent and “d” is a private key exponent. “M” is a message sent from a sender to a receiver and “C” is computed ciphertext.

During the encryption stage, the controller 310 receives data input 315 of clear message M, data input 320 of exponent e, and data input 325 of modulus n and performs the following equation (A) to generate data output 355 of encrypted message C:

C≡M^{e} mod n. (A)

During the decryption stage, the controller 310 receives data input 315 of encrypted message C, data input 320 of exponent d, and data input 325 of modulus n, and performs the following equation (B) to generate decrypted output data 355 of clear message M:

M≡C^{d} mod n. (B)

In one embodiment, the exponentiator state machine 335 controls operations of the modulus multiplier 350 to perform modulus exponentiation functions efficiently. Depending on the inputs received from the CPU 305, the exponentiator state machine 335 commands the modulus multiplier 350 to perform encryption, decryption, or authentication using memory registers or other types of memory (such as RAM or Flash memory). In another embodiment, a general purpose CPU performs the functions of an exponentiator state machine and modulus multiplier using memory registers or other types of memory.

A major task associated with public key calculations is resolving the equations (A) and (B) in an efficient manner in terms of resources and time required. In one embodiment, memory 340 on the controller 310 is configured to reduce the number of cycles required to perform the equations (A) and (B). Alternately, the functions of the controller may be executed by a CPU with a portion of general purpose memory or register memory likewise configured. In either case, the structure of the memory used during performance of the calculation of equations (A) and (B) plays an integral role in terms of the speed and resources required.

The techniques of “exponentiation by squaring” and “binary multiplication,” when used in conjunction, convert the task of exponentiation into more simple register shift and addition routines. To complete the modulus multiplication procedure, required for public key calculations, comparison and subtraction routines are employed.

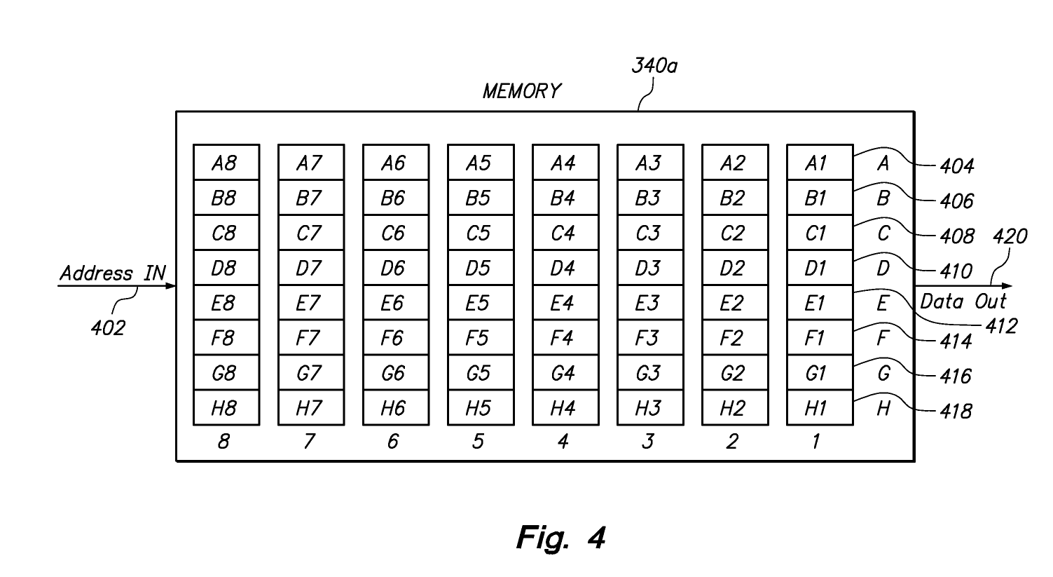

FIG. 4 depicts a prior art method for employing memory to contain s bit values used in public key calculations. Consider the s^{th} bit value which is parsed into v equal bit sub-lengths, each with a length of t, labeled “A1” to “A8”, where “A1” represents the t least significant bits (LSB) and “A8” represents the t most significant bits (MSB).

To illustrate the concept, an example exponent (multiplicand) is 1024 bits long. FIG. 4 shows a memory block 340a containing an array of 8×8 registers. There is an address in 402 and a data out 420. The 64 registers are arranged into eight rows and eight columns of sub-blocks, each sub-block able to store 128 bits of data. The rows are labeled A, B, C, D, E, F, G, and H while the columns are labeled 1, 2, 3, 4, 5, 6, 7, and 8. Each row is configured as a register: A exponent register (exreg 404), B multiplication register (multreg 406), C square register, (sqreg 408), D product register (prodreg 410), E temporary register (tempreg 412), F multiplicand register (mcreg 414), G modular register (modreg 416), and H multiplier register (mpreg 418).

Operations such as addition, subtraction and comparison are performed at a sub-block level. For example, to add the value of multiplication register represented by B 406 with the value of temporary register, represented by E 412, the exponentiator state machine 335, or computer, fetches the value B1 and fetches the value E1, using two different fetch cycles, one for row B and one for row E, and then performs an addition operation. The resultant carry value is then added to values of B2 and E2, and written to temporary register 412. Then two additional fetch cycles are used to fetch B2 and E2 to perform the next addition operation. The process is repeated along the row to the last values B8 and E8.

In total, the addition of B to E requires at least 16 cycles (one each for B1 to B8 and one each for E1 to E8) just to fetch data from B and E. In traditional systems, when operations such as add, subtract, and compare are performed, each sub-block is addressed separately, increasing the number of cycles required and thus adding latency to the process.

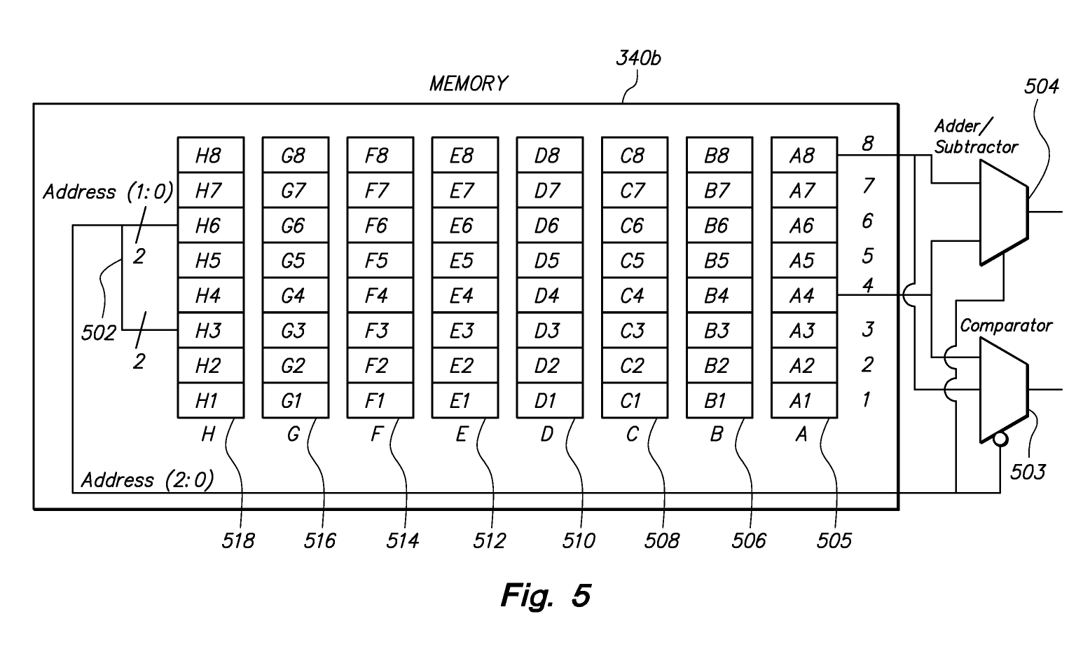

Designing memory to reduce resources as well as time required to perform calculations associated with computing equations (A) and (B) improves the efficiency of public key calculations. Shown in FIG. 5 is an example of one such type of memory structure disclosed herein. While it is more efficient to implement the memory structure in hardware, it is also possible to implement it as a data structure in a general purpose computer memory.

A memory block 340b, configured in accordance with the present invention and shown in FIG. 5, is partitioned into sub-blocks similar to the way memory block 340a shown in FIG. 4 is partitioned. However, importantly, the rows and columns are exchanged compared to FIG. 4.

FIG. 5, like FIG. 4, uses an example exponent (multiplicand) 1024 bits long. FIG. 5 shows a memory block 340b containing an array of 8×8 registers. The 64 registers are arranged into eight rows and eight columns of sub-blocks, each sub-block able to store 128 bits of data. Reversing the arrangement of FIG. 4, the rows in FIG. 5 are labeled 1, 2, 3, 4, 5, 6, 7, and 8, while the columns are labeled A, B, C, D, E, F, G, and H. Each column is now configured as a register: A exponent register (exreg 505), B multiplication register (multreg 506), C square register, (sqreg 508), D product register (prodreg 510), E temporary register (tempreg 512), F multiplicand register (mcreg 514), G modular register (modreg 516), and H multiplier register (mpreg 518).

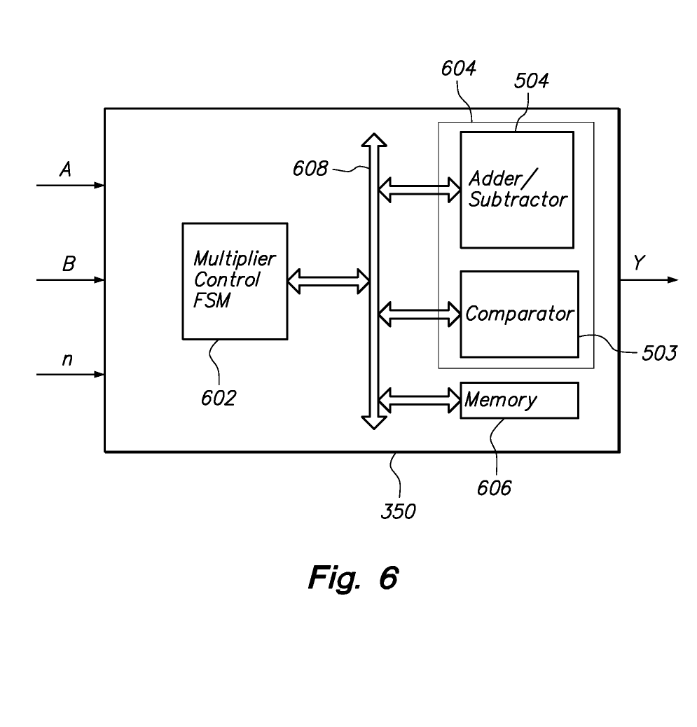

The mcreg 514 is a modular multiplier register which stores the initial multiplicand input (denoted as A in FIG. 6) and is also reused during the iterative computation. The mpreg 518 is a modular multiplier register which stores the initial multiplier input (denoted as B in FIG. 6) and is also reused during the iterative computation. The modreg 516 is the modular multiplier modulus input (denoted as n in FIGS. 6 and 325 in FIG. 3) used during the iterative computation. The prodreg 510 holds the temporary and final result (denoted as Y in FIG. 6) of the modulus multiplier 350 (FIG. 3 and FIG. 6).

Addressing a row sub-block in FIG. 4 yields, for example, a value of the exponent register 505 represented by A (404), whereas addressing by rows using the proposed configuration will allow fetching 128 bit values of different registers. For example, addition of the value of multiplication register represented by B (506) with the value of temporary register represented by E (512), multiplier control finite state machine 602 may fetch simply the first row to obtain the value of B1 and the value of E1 and use just one fetch cycle. That is, one cycle is needed to fetch row 1.

After performing an addition operation, the resultant value of carry can be added to the corresponding values of B2 and E2. Thus, the addition of B and E using the FIG. 5 configuration requires only 8 cycles instead of 16 cycles using the prior art method.

Including addressing 502, adder/subtractor circuitry 504, and comparator circuitry 503 also increases the speed of calculation.

Equations (A) and (B) are solved by performing the following three arithmetic operations:
1. multiplicand−mod
2. prod+multiplicand, shift left of the multiplicand
3. prod−mod

In the arithmetic operations 1 and 3 involving subtraction, it is efficient to perform the comparison and subtraction in parallel. In FIG. 5, subtraction and comparison are performed by fetching data in parallel starting at LSB for subtraction and starting at MSB for comparison. If the MSB of the mod is greater than the MSB of the multiplicand, the subtraction of the values will result in a negative value; subtraction need not be performed and thus halted.

FIG. 6 depicts the preferred hardware embodiment of the invention. Components of the modulus multiplier 350 include multiplier control finite state machine 602, circuitry 604 and memory 606, as well as a bus 608 providing communication among the modulus multiplier 350 components. Circuitry 604 corresponds to adder/subtractor circuitry 504 and comparator circuitry 503 in FIG. 5, while memory 606 corresponds to memory 340b in FIG. 5. Modulus multiplier 350 performs modular multiplication and modular square iteratively (up to 2w times where w is the number of bits of the exponent). Each time the modulus multiplier 350 is called to compute a multiplication or square, it receives inputs multiplicand A, multiplier B, and modulus n. These inputs are controlled and feed by exponentiator state machine 335, shown in FIG. 3. The modulus multiplier 350 outputs the modular exponent Y.

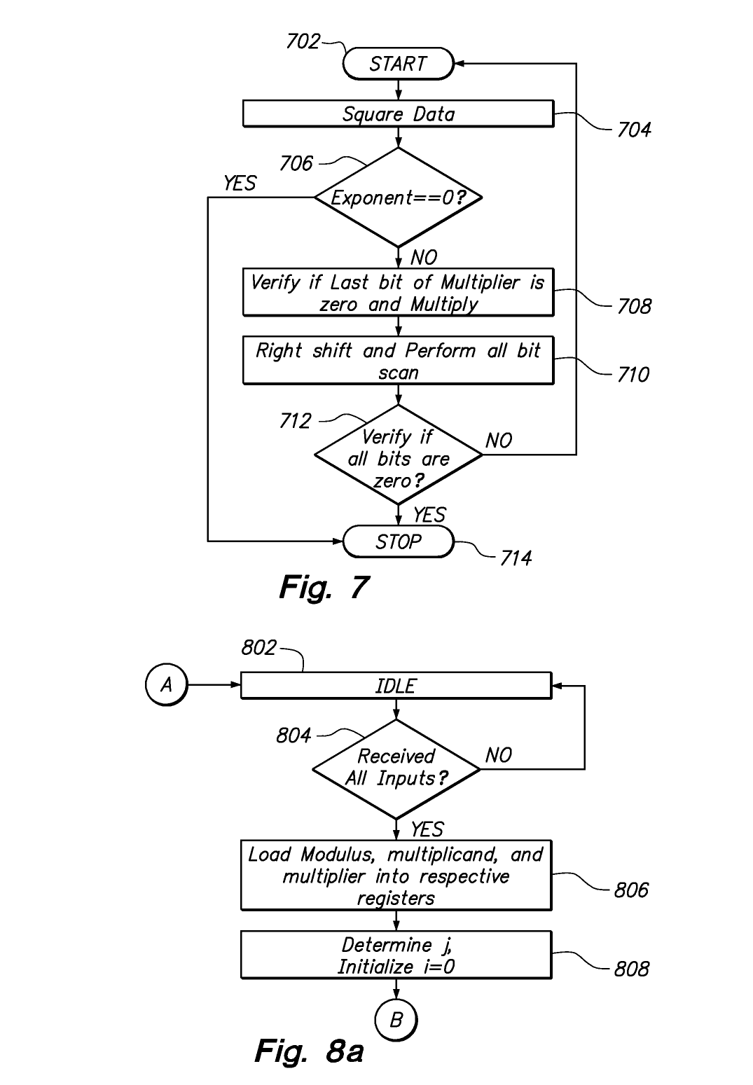

FIG. 7 is an overview of the inventive method that computes equations (A) and (B). At start 702, data (i.e., multiplicand, multiplier, and modulus) are fetched and then squared at step 704. Then the exponent is checked 706; if it is equal to zero, then the routine stops 714, otherwise the last bit of the multiplier is compared to zero and the data are multiplied 708. Data are right shifted 710 and an all bit scan is performed. If all bits are zero, step 712, then the routine stops 714, otherwise the method returns to start 702.

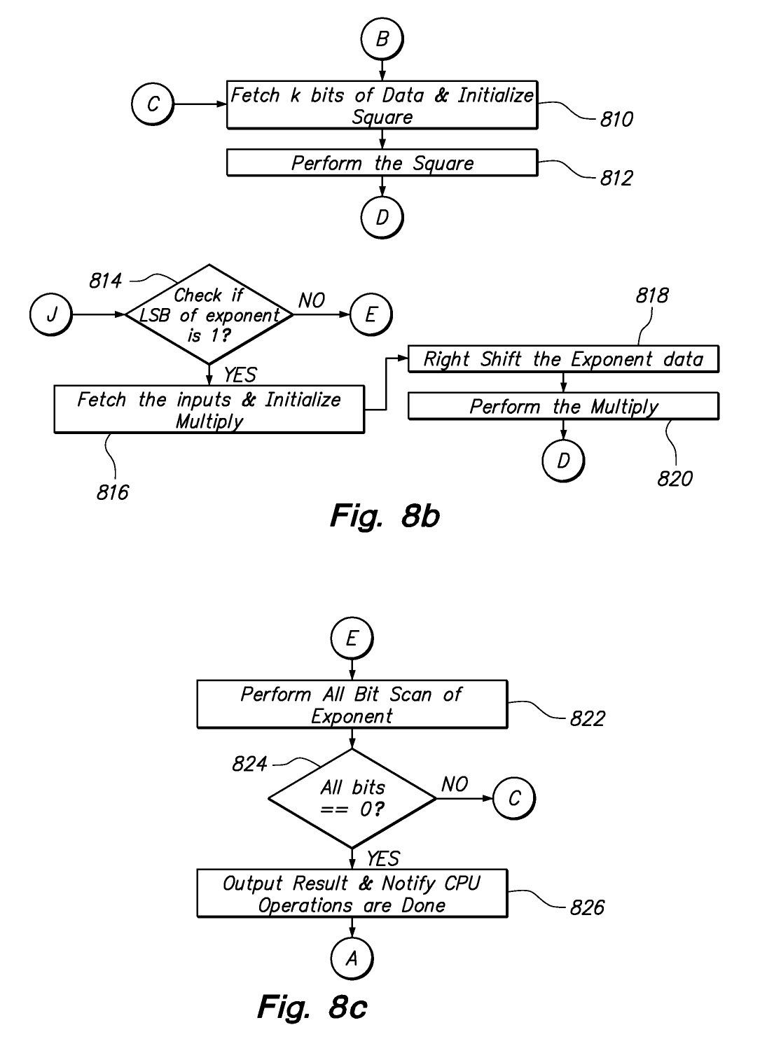

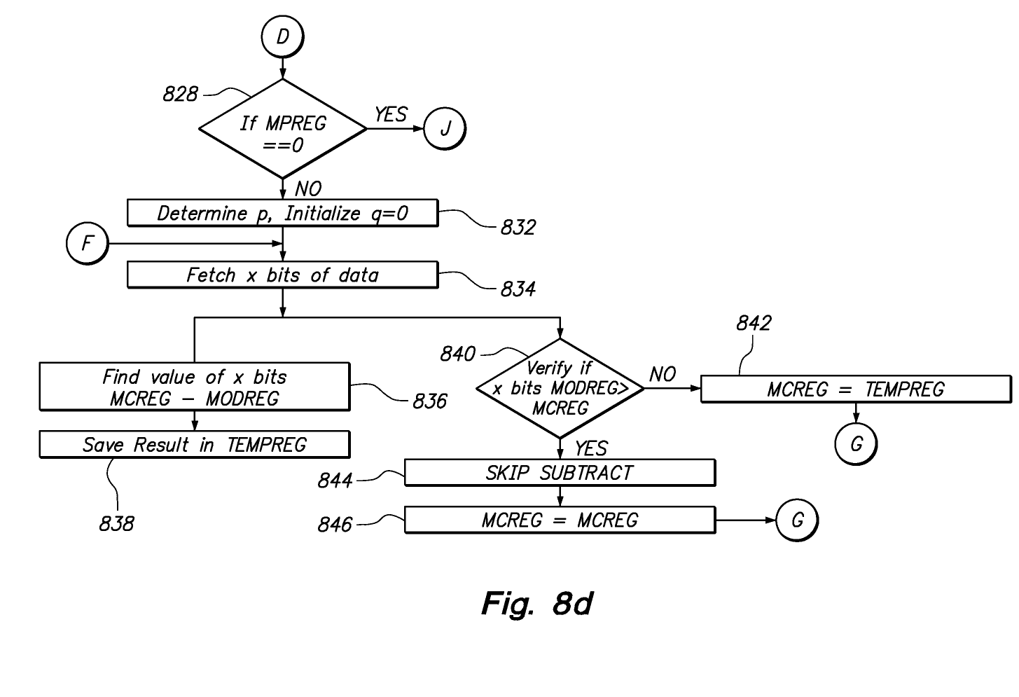

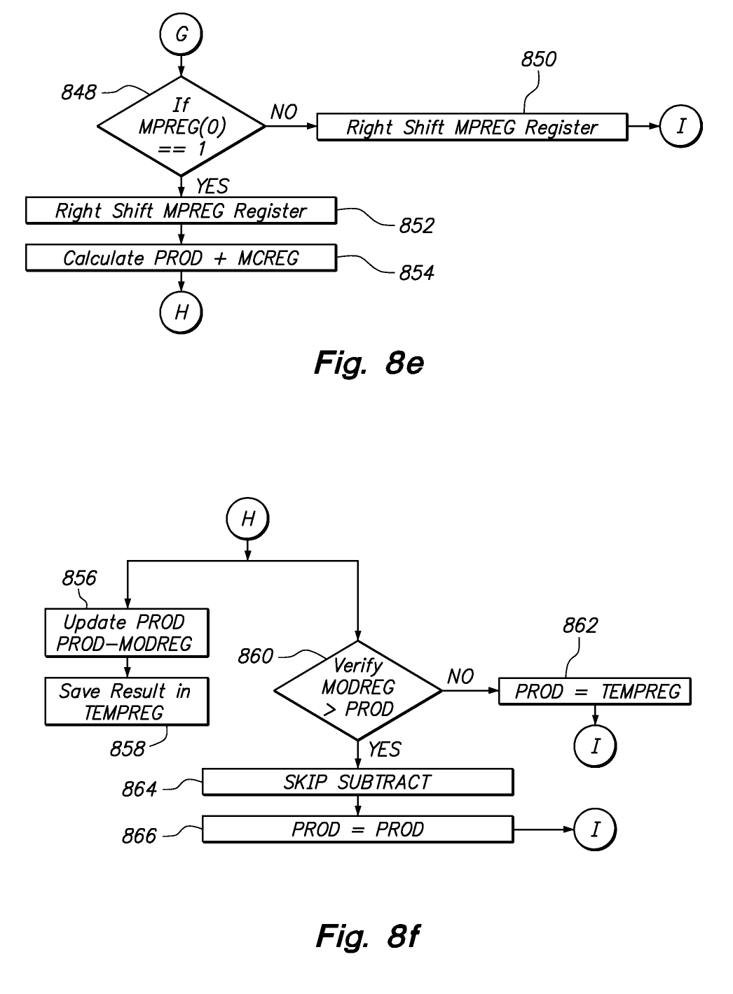

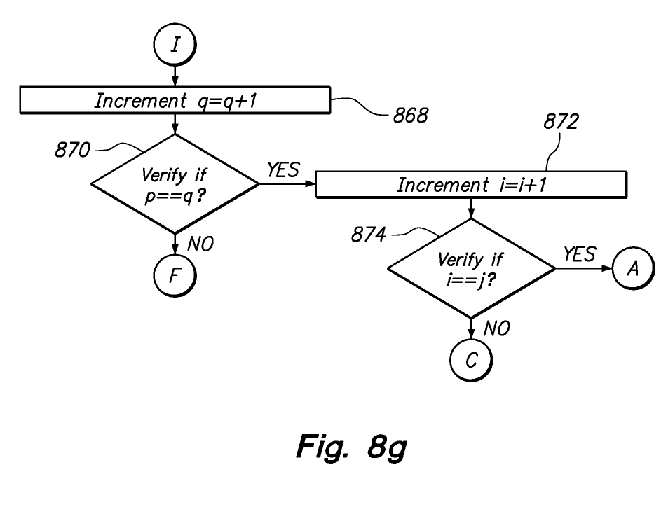

FIGS. 8a, 8b, 8c, 8d, 8e, 8f, and 8g illustrate the operation of the controller 310 (or a computer system) to compute the equations (A) and (B). On receiving power, the controller 310 can be programmed to operate in the idle state (step 802). Exponentiator state machine 335 verifies if the data inputs 315, 320 and 325 are received from the CPU 305 on predetermined time intervals. If all the inputs are not received, the controller 310 returns to the idle state (step 804). On the other hand, if all the inputs from the CPU 305 are received, multiplicand A, multiplier B, and modulus n are loaded into appropriate registers (step 806). The data, exponent, and modulus are divided into j blocks of k bit lengths, and i is initialized to zero (step 808).

Exponentiator state machine 335 commands the modulus multiplier 350 to fetch k bits of data (i.e., multiplicand, multiplier, and modulus) and initialize square operation (step 810). The square operation is performed after receiving the inputs (step 812). The method of performing the square and multiply operations (square and multiply operations are performed using the same circuitry as they involve multiplying of two values) are explained in detail in FIGS. 8d, 8e, 8f and 8g. After the square operation is performed, the modulus multiplier 350 examines the LSB of the k bits of the exponent value (exreg 505) at step 814. If the LSB of the exponent value is ‘1’, then multiplication is initialized (step 816). The exponent value (exreg 505) is shifted right (step 818). After the exponent value (exreg 505) is shifted to the right, multiplication is performed (step 820). On the other hand, if the LSB of the exponent is not equal to ‘1’, all bits of the exponent value (exreg 505) are scanned (FIG. 8c, step 822). If any bit of the exponent value (exreg 505) is verified to be non-zero, then the exponentiator state machine 335 returns to step 810 (step 824). On the other hand, if all bits are zero, the exponentiator state machine 335 will output the modular exponent result Y and the controller 310 will notify the CPU that all the operations are done (step 826).

If either square or multiply process is initiated, the modulus multiplier 350 determines if the value of the multiplier (mpreg 518) is zero (step 828). If the value of the multiplier (mpreg 518) is zero, the modulus multiplier 350 proceeds to step 814. If the value of multiplier (mpreg 518) is not equal to zero, the modulus multiplier divides the data into p segments each x bits long and initializes q to zero (step 832). Modulus multiplier 350 fetches x bits of data and performs arithmetic operation 1 (step 834). The modulus multiplier 350 performs both comparison and subtraction operations of the values stored in mcreg 514 and modreg 516 in parallel (steps 836 and step 840). If the value of the modulus is greater than the multiplicand then the subtraction is skipped (step 844) and the multiplicand value is not updated (step 846). If the value of the modulus is not greater than the value of the multiplicand, the subtraction is completed and the value is saved in tempreg 512 (step 838) and the multiplicand value (mcreg 514) is updated to the value stored in tempreg 512 (step 842).

Once the multiplicand value is updated, the LSB of the multiplier is verified (step 848). If the LSB of the multiplier is not equal to ‘1’ then the multiplier is right shifted (step 850) and the value of q is incremented by 1 (step 868). If the LSB of the multiplier is equal to ‘1’ then the multiplier is right shifted (step 852) and the value of the multiplicand is added to the value of the product register 510 and the value of the product register 510 is updated with resulting sum (step 854).

Modulus multiplier 350, after performing arithmetic operation 2 in step 854, performs both comparison and subtraction operations of the values of product register 510 and modulus register 516 in parallel (step 856 and step 860). If the value of the modulus is greater than the product, then the subtraction is skipped (step 864) and the product value (prodreg 510) is not updated (step 866). If the value of the modulus is not greater than the value of the product, the subtraction is completed and the value is saved in the tempreg 512 (step 858) and the product value (prodreg 510) is updated to the value stored in the tempreg 512 (step 862).

After the new value of the product is determined, the value of q is incremented by 1 (step 868). The value of q is compared with value of p and if they are equal, the modulus multiplier 350 returns to step 834 (step 870). Otherwise, the value of i is incremented by 1 (step 872). The value of i is compared with the value of j and if they are equal, the modulus multiplier 350 proceeds to step 802 and if they are not equal, the modulus multiplier 350 returns to step 810 (step 874).

The method of this invention is further illuminated by reference to the following pseudocode:

```
/***********************************************************************/
Solve: Output = A^{B} mod n  /* which is equivalent to:  */
        Output = A^{B}_{bin} mod n  /*  or . . . */
  Output = A^{b(0),b(1), . . .,b(k-1)} mod n  /*where b(k-1) is the most significant non-zero
bit and bit b(0) is the least significant bit */
/**********************************************************************/
Set Output = A
```

| | |
|---|---|
| For i = 0 to k-1 | /* beginning of loop through bits of B */ |

| | |
|---|---|
| if b == 0 then | /* look at value of current bit */ |

```
          return Output
  else if b(i) == 0 then
Call  MULTI (Output, Output, n)  /* Call subroutine MULTI to solve:
```

| | |
|---|---|
| | Output = (Output * Output) mod n */ |
| else if b(i) == 1 then | |
| Call MULTI (A, Output, n) | /* Call subroutine MULTI to solve: |
| | Output = (Output * A) mod n */ |

```
  End
Next i
  return Output
/*****************************************************************/
/* Subroutine MULTI which is the Modulus Multiplier */
/* Solve (A * B) mod M */
  MULTI (A, B, M)
        Initialize variables
  Begin
```

| | | |
|---|---|---|
| MPREG | = A_{bin} | /* Insert bits representing A into register MP */ |
| MCREG | = B_{bin} | /* Insert bits representing B into register MC */ |
| MOD | = M_{bin} | /* Insert bits representing n into register MOD */ |
| PROD | = 0 | |
| TMPREG | = Don't Care | |

```
  End
For (i = 0; i < Depth; i = i + 1)
Begin
  MPREG_D = MPREG[i]
  While (MPREG_D != 0)
  Begin
    1 For (j = 0; j < Depth; j = j + 1)
    Begin
    a. TMPREG = MCREG[j] − MOD[j]
    b. Compare MCREG [Depth-j] with MOD [Depth-j]
      If MOD is greater than MCREG then skip the Subtraction.
    End
  2. If MCREG > MOD
      MCREG = TMPREG << 1 [Note2]
    Else
      MCREG = MCREG << 1  [Note2]
  3. If MPREG (0) = 1
  For (k = 0; k < Depth; k = k + 1)
  Begin
    PROD[k] = PROD[k] + MCREG[k]
  End
  4. If MPREG (0) = 1
  For (m = 0; m < Depth; m = m + 1)
  Begin
    a. TMPREG[m] = PROD[m] − MOD[m]
    b. Compare PROD [Depth-m] with MOD [Depth-m]
    If MOD is greater than PROD then skip the Subtraction.
  End
  5. If PROD > MOD
    PROD = TMPREG
    Else
    PROD = PROD
  6. a. MPREG_D = MPREG_D >> 1
    b. If MPREG_D = 1 then
      For (n = i+1; n < Depth; n = n + 1)
      Begin
      Compare MPREG [n] with 0
      [for first iteration compare with 1 & rest of it with 0]
      If MPREG = 1 exit both WHILE & FOR Loop(Multiplier done)
      End
  End while
End
/****************************************************************/
Note : << Indicates Left shift by appending 0 at the 0^{th} bit.
      >> Indicates Right shift by appending 0 at the MSB (Nth) bit.
      Step 6 is running simultaneously on step 3.
      Step 2 is running simultaneously on step 3 when MPREG (0) = 1
      Else on step 1 itself.
Note2: Shifter Implementation
        Begin
        REG_D = REG[MSB BIT]
        REG = REG[Width-1:0] & ‘0’  (Concatenation)
        For (i = 1; i < Depth; i = i + 1)
        Begin
          REG = REG[Width-1:1] & REG_D
        End
        End
Register Width = Implementation Width
Register Depth = RSA Width/ Register Width
Example: RSA Width = 1024
          Register Width = 128 (128 bit Adder)
          Register Depth = 8
/**************************************************************************/
```

While various embodiments have been described above, it should be understood that they have been presented by way of example only, and that the breadth and scope of the invention should not be limited by any of the above-described exemplary embodiments, but should instead be defined only in accordance with the following claims and their equivalents. While the particular SYSTEM AND METHOD FOR MOD-EXPONENTIATOR as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claims.

It is claimed:

1. A memory comprising:
rows of cells containing dissimilar data types, and
columns of cells containing similar data types,
wherein binary multiplication operations fetch rows and binary multiplication operations store intermediate results in columns.

2. The memory of claim 1 wherein the rows of cells are registers and the columns of cells are registers.

3. A modulus multiplier comprising a memory, a multiplier control finite state machine, an adder/subtractor, a comparator, means for addressing memory, and a bus providing data communication between the finite state machine and memory, wherein the memory comprises rows of cells containing dissimilar data types, and columns of cells containing similar data types and wherein the finite state machine executes binary multiplication operations which fetch rows of cells and binary multiplication operations which store intermediate results in columns of cells.

4. The modulus multiplier of claim 3 wherein the rows of cells are registers and the columns of cells are registers.

5. The modulus multiplier of claim 3 further comprising an adder/subtractor and a comparator wherein the bus provides data communication among the finite state machine, memory, adder/subtractor, and comparator.

6. The modulus multiplier of claim 4 further comprising an adder/subtractor and a comparator wherein the bus provides data communication among the finite state machine, memory, adder/subtractor, and comparator.

7. A method of binary multiplication comprising:
addressing rows of cells containing dissimilar data types, and
addressing columns of cells containing similar data types,
wherein binary multiplication operations fetch rows of cells and binary multiplication operations store intermediate results in columns of cells.

8. The method of claim 7 wherein the rows of cells are registers and the columns of cells are registers.

9. A method of modulus multiplication comprising:
providing a modulus multiplier comprising a memory, a multiplier control finite state machine, means for addressing memory, and a bus providing data communication between the finite state machine, and memory wherein the memory comprises rows of cells containing dissimilar data types, and columns of cells containing similar data types, and
the finite state machine executing binary multiplication operations which fetch rows of cells and binary multiplication operations which store intermediate results in columns of cells.

10. The method of claim 9 wherein the rows of cells are registers and the columns of cells are registers.

11. The method of claim 9 wherein the modulus multiplier further comprises an adder/subtractor and a comparator wherein the bus provides data communication among the finite state machine, memory, adder/subtractor, and comparator.

12. The method of claim 10 wherein the modulus multiplier further comprises an adder/subtractor and a comparator wherein the bus provides data communication among the finite state machine, memory, adder/subtractor, and comparator.
